(19) United States
(12) Patent Application Publication
(10) Pub. No.: US 2016/0132416 A1
(43) Pub. Date: May 12, 2016

(54) COMMUNICATION MONITORING SYSTEM

(71) Applicant: Hitachi Metals, Ltd., Tokyo (JP)

(72) Inventors: Yohei SHIRAKAWA, Hitachi (JP); Koki Hirano, Hitachinaka (JP); Yoshitake Ageishi, Hitachi (JP)

(21) Appl. No.: 14/929,284

(22) Filed: Oct. 31, 2015

(30) Foreign Application Priority Data
Nov. 11, 2014 (JP) 2014-228955

(51) Int. Cl. G06F 11/30; G06F 13/40

(52) U.S. Cl. CPC G06F 11/3051; G06F 11/3041; G06F 13/4022

(57) ABSTRACT

A communication monitoring system includes a plurality of detecting portions each provided at a connector at an end of a communication cable or at a relay connector to be connected to the connector to branch, extract and output a portion of a signal transmitted through the communication cable, and a monitoring unit configured to monitor an existence of information communication through each of the communication cables provided with the detecting portions based on an output from the plurality of detecting portions.

### The present application is based on Japanese patent application No.2014-228955 filed on Nov. 11, 2014, the entire contents of which are incorporated herein by reference.

### BACKGROUND OF THE INVENTION

1. Field of the Invention

The invention relates to a communication monitoring system.

2. Description of the Related Art

In data centers etc., the connection of a communication cable such as a LAN (Local Area Network) cable may be altered in accordance with layout change, displacement or addition of information and communication device such as a server or a hub.

Some information and communication devices are provided with a connection check lamp for checking the connection of communication cables so as to determine whether or not the communication cable is connected.

Also, a device has been proposed in which the connection of the communication cable is monitored by detecting the insertion and removal of the connector of the communication cable (see e.g., JP-B-5274671).

### SUMMARY OF THE INVENTION

The conventional devices can only check the physical connection of the communication cable. Thus, it is not possible to check whether the communication is actually established through the communication cable.

The communication cable may be erroneously removed without noticing the establishment of communication. Thus, a failure may be caused which includes a service shutdown of the information communication device and a data corruption during transfer.

Where the connection of the communication cable is monitored as in JP-B-5274671, the communication cable needs a built-in monitoring signal line. Since a versatile communication cable is thus difficult to use therewith, the manufacturing cost may increase.

Furthermore, in a large-scale communication facility such as a data center, it is desired to collectively monitor the establishment of the communication through many communication cables.

It is an object of the invention to provide a communication monitoring system that can collectively monitor the establishment of the communication through multiple communication cables and can prevent the erroneous removal of the communication cables while using versatile communication cables.

(1) According to an embodiment of the invention, a communication monitoring system comprises:

a plurality of detecting portions each provided at a connector at an end of a communication cable or at a relay connector to be connected to the connector to branch, extract and output a portion of a signal transmitted through the communication cable; and

a monitoring unit configured to monitor an existence of information communication through each of the communication cables provided with the detecting portions based on an output from the plurality of detecting portions.

In the above embodiment (1) of the invention, the following modifications and changes can be made.

(i) The monitoring unit comprises: a switching circuit comprising a plurality of input ports to receive an output of the plurality of detecting portions and one output port and sequentially changing the input ports to be connected to the output port; and a determination portion sequentially determining the existence of information communication at the plurality of detecting portions based on an output from the output port of the switching circuit.

(ii) The determination portion determines that there is information communication at arbitrary one of the detecting portions if the information communication at the arbitrary one changes from “existing” to “not existing”, and that there is no information communication at the arbitrary one if the information communication at the arbitrary one changes from “not existing” to “existing”.

(iii) The determination portion determines that there is information communication at arbitrary one of the detecting portions if the information communication at the arbitrary one is detected to be “existing” for multiple times in succession, and that there is no information communication at the arbitrary one if the information communication at the arbitrary one is detected to be “not existing” for multiple times in succession.

(iv) The monitoring unit comprises an output section for outputting information about the existence of the information communication at each of the detecting portions through a wire or wirelessly, and a mobile terminal device for receiving and displaying the information from the output section.

(v) The detecting portions comprise a matching circuit configured to adjust a level of the signal extracted from the communication cable.

(vi) One of the detecting portions and the monitoring unit comprises an amplifier circuit amplifying the signal extracted from the communication cable and outputting the amplified signal, a rectifier circuit rectifying an output from the amplifier circuit into a DC signal and outputting the DC signal, and a comparator outputting a signal with a predetermined voltage if output voltage of the rectifier circuit is not less than a preset threshold voltage.

(vii) The monitoring unit comprises the amplifier circuit, the rectifier circuit and the comparator.

(viii) The monitoring unit comprises an alarm portion that sets at least one of the plurality of detecting portions as a key monitoring object and outputs an alarm if the information communication at the detecting portions as the key monitoring object is determined to be “not existing”.

### EFFECTS OF THE INVENTION

According to an embodiment of the invention, a communication monitoring system can be provided that can collectively monitor the establishment of the communication through multiple communication cables and can prevent the erroneous removal of the communication cables while using versatile communication cables.

### BRIEF DESCRIPTION OF THE DRAWINGS

Next, the present invention will be explained in more detail in conjunction with appended drawings, wherein:

FIG. 1A is an illustration diagram showing a communication monitoring system in an embodiment of the present invention;

FIG. 1B is an illustration diagram showing a detecting portion in the communication monitoring system;

FIG. 1C is an illustration diagram showing a monitoring unit in the communication monitoring system;

FIG. 2 is perspective view showing a relay connector used in the communication monitoring system;

FIG. 3 is a timing chart showing a timing of determining the communication state at each detecting portion in the communication monitoring system;

FIG. 4 is a flow chart showing a control flow of the communication monitoring system;

FIG. 5A is an illustration diagram showing a detecting portion in a modified communication monitoring system according to the invention; and

FIG. 5B is an illustration diagram showing a monitoring unit in the modified communication monitoring system.

### DETAILED DESCRIPTION OF THE PREFERRED EMBODIMENTS

An embodiment of the invention will be described below in conjunction with the appended drawings.

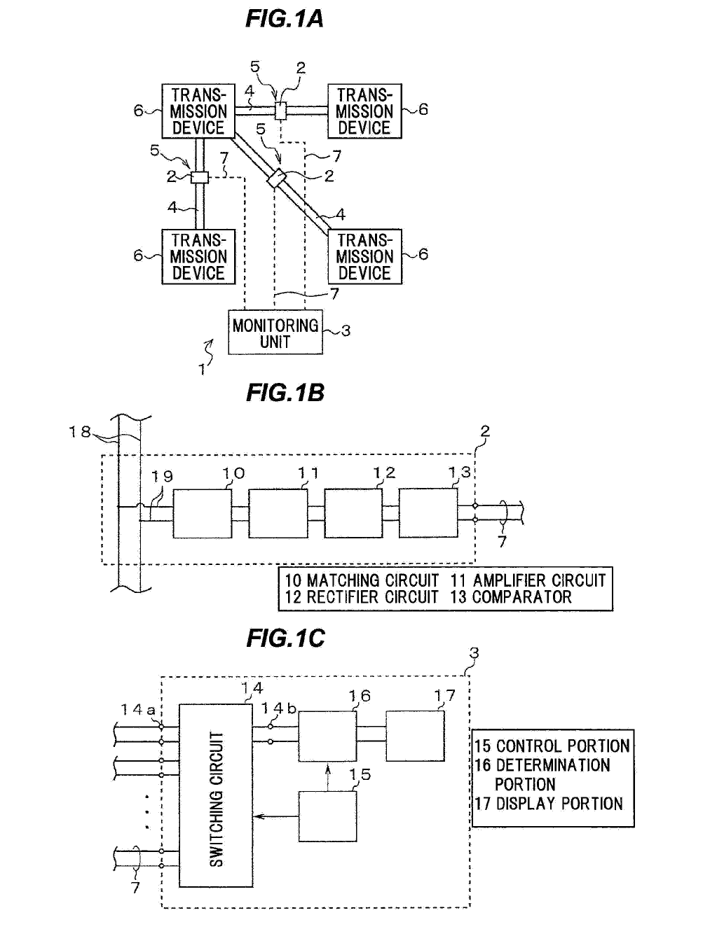

FIG. 1A is an illustration diagram showing a communication monitoring system in an embodiment of the present invention. FIG. 1B is an illustration diagram showing a detecting portion in the communication monitoring system. FIG. 1C is an illustration diagram showing a monitoring unit in the communication monitoring system.

As shown in FIGS. 1A to 1C, a communication monitoring system 1 is provided with plural detecting portions 2 and a monitoring unit 3.

The detecting portion 2 serves to branch and extract a portion of a signal transmitted through a communication cable 4 and to output the extracted signal to the monitoring unit 3, and is provided in a connector provided at an end of the communication cable 4 or in a relay connector 5 to be connected to such a connector. The detecting portion 2 when provided in the relay connector 5 will described here.

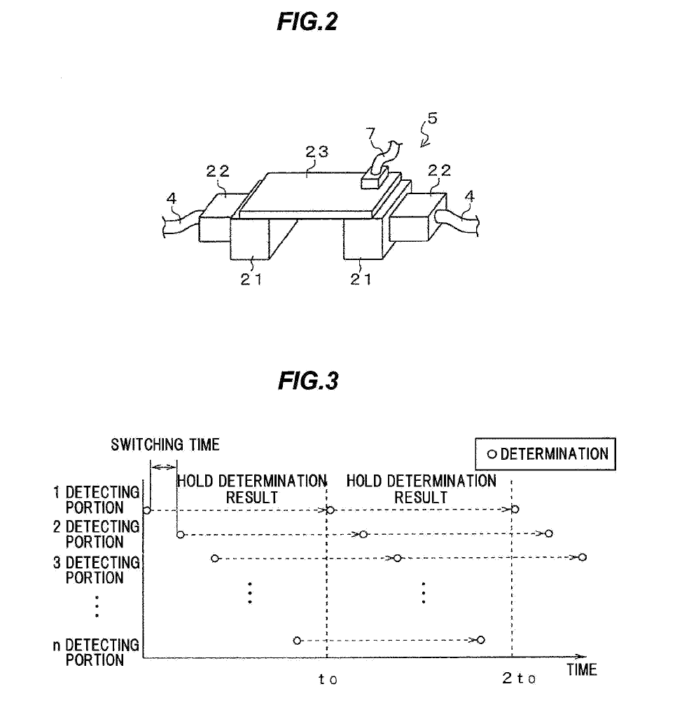

As shown in FIG. 2, the relay connector 5 is provided with two connectors 21, and the communication cables 4 connected to the two connectors 21 are connected to each other via the relay connector 5. The connector 21 is, e.g., a jack connector conforming to the RJ45 standard and is connectable to a connector 22 (e.g., a plug connector conforming to the RJ45 standard) provided at an end of the communication cable 4.

The both connectors 21 are mounted on a circuit board 23 on which a signal transmission unit is provided to transmit signals between the two connectors 21. In the communication monitoring system 1, the detecting portion 2 is mounted on the circuit board 23. Then, a monitoring cable 7 for connecting the detecting portion 2 to the monitoring unit 3 extends from circuit board 23.

As the communication cable 4, it is possible to use a universal LAN (Local Area Network) cable. The communication cable 4 having four pairs of signal lines (eight in total) for transmitting differential signals is used in the present embodiment.

As shown in FIGS. 1A and 2, when the communication cable 4 extending from one transmission device 6 is connected to one of the connectors 21 of the relay connector 5 and the communication cable 4 extending from another transmission device 6 is connected to the other connector 21, the two transmission devices 6 are communicatively connected through the relay connector 5. The transmission devices 6 are, e.g., information and communication equipments such as servers or hubs.

As shown in FIG. 1B, in the present embodiment, the detecting portion 2 is composed of a matching circuit 10, an amplifier circuit 11, a rectifier circuit 12 and a comparator 13 which are connected sequentially.

The matching circuit 10 is to provide impedance matching in a predetermined frequency band. In the present embodiment, since a portion of the signal transmitted through the communication cable 4 (the signal transmitted between the two connectors 21) is branched and extracted, the matching circuit 10 also serves to adjust the level of a signal extracted from the communication cable 4.

In the present embodiment, four differential signals are transmitted between the two connectors 21 and a signal transmission unit having four pairs of transmission paths is thus formed. Then, branch transmission paths 19 branched from a given pair of transmission lines 18 enter the matching circuit 10. The matching circuit 10 is configured to appropriately include, e.g., a resistive circuit and LC filter, etc.

The amplifier circuit 11 is a circuit which amplifies the signal extracted from a given transmission line 18 through the matching circuit 10 and outputs the amplified signal to the downstream rectifier circuit 12. As the amplifier circuit 11, it is possible to use, e.g., a grounded emitter circuit. However, the specific configuration of the amplifier circuit 11 is not limited thereto. Although the amplifier circuit 11 is a single-stage configuration in the present embodiment, the amplifier circuit 11 may be a multistage configuration.

The rectifier circuit 12 rectifies the AC signal amplified by the amplifier circuit 11 into a DC signal and outputs the DC signal to the downstream comparator 13. As the rectifier circuit 12, it is possible to use a well-known full-wave rectifier circuit or half-wave rectifier circuit.

The comparator 13 is a circuit which is turned on and outputs a DC signal with a predetermined voltage when the output voltage of the rectifier circuit 12 is not less than a preset threshold voltage (offset voltage). The output from the comparator 13 is sent to the monitoring unit 3 through the monitoring cable 7.

Providing the comparator 13 allows a signal with a constant voltage to be output even when the output voltage of the rectifier circuit 12 is small as long as offset voltage of the comparator 13 is set to a low level, and it is thereby possible to stably monitor the communication state by the monitoring unit 3.

Therefore, it is possible to reduce the level of the extracted signal by increasing the resistance value of the matching circuit 10, which reduces reflection loss and insertion loss and thus suppresses deterioration in quality of the signal.

Meanwhile, strength of the signal transmitted through the communication cable 4 may be different depending on the transmission device 6 connected to the communication cable 4 or length of the communication cable 4. However, since the comparator 13 is provided, it is possible to stably monitor the communication state even when the strength of the signal transmitted through the communication cable 4 is small.

Furthermore, since the output voltage of the rectifier circuit 12 can be reduced, it is possible to reduce output voltage of the amplifier circuit 11, to lower power consumption, and even to suppress deterioration in signal quality caused because the output signal of the amplifier circuit 11 enters the communication cable 4.

The detecting portion 2 is provided with the amplifier circuit 11 and the comparator 13 and thus requires a power source. The power source may be a battery provided on the detecting portion 2 or an external source to supply power from outside. Alternatively, power may be supplied to the detecting portion 2 from the monitoring unit 3 through the monitoring cable 7.

As shown in FIG. 1C, the monitoring unit 3 is provided with a switching circuit 14, a control portion 15, a determination portion 16 and a display portion 17.

The switching circuit 14 has plural input ports 14a respectively receiving outputs of the plural detecting portions 2 and one output port 14b, and is configured to sequentially change the input port 14a to be connected to the output port 14b. The monitoring cables 7 extending from the detecting portions 2 are respectively connected to the input ports 14a and the output port 14b is connected to the determination portion 16. Switching of the switching circuit 14 is controlled by the control portion 15.

The determination portion 16 sequentially determines the communication states at the plural detecting portions 2 based on the output from the output port 14b of the switching circuit 14. A control signal is input from the control portion 15 to the determination portion 16 which then determines each communication state in synchronization with the switching operation of the switching circuit 14.

When output voltage of the switching circuit 14, i.e., output voltage of the comparator 13 of a detecting portion 2 is higher than the preset threshold voltage, the determination portion 16 determines that information communication is existing at the detecting portion 2.

The display portion 17 indicates the communication state at each detecting portion 2 based on the determination of the determination portion 16. The display portion 17 may be configured to include, e.g., a display such as a monitor screen. Alternatively, the display portion 17 may be configured to indicate the communication states at the detecting portions 2 by means of light emission of light-emitting elements respectively corresponding to the detecting portions 2.

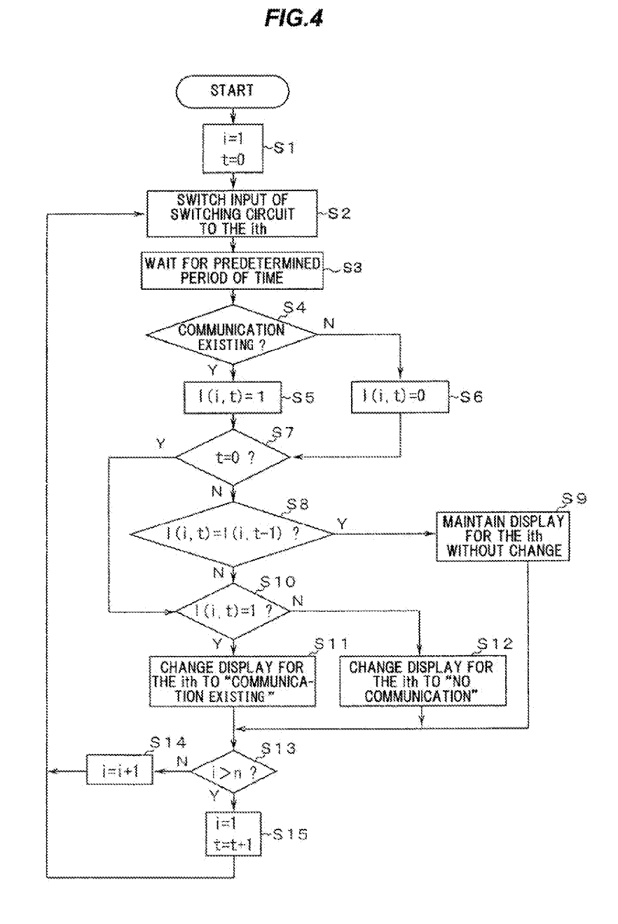

As shown in FIG. 3, in the present embodiment, the communication state at each detecting portion 2 is determined by sequentially switching the switching circuit 14, such that the communication state at a given detecting portion 2 is determined, switching of the switching circuit 14 is then performed, and the communication state at the next detecting portion 2 is determined after waiting until the switching operation is stabilized. Therefore, the determination portion 16 is configured that, after determining the communication state at a given detecting portion 2, the last determination of this detecting portion 2 is held until the communication state thereof is determined again.

In detail, the determination portion 16 determines that information communication is not existing at a given detecting portion 2 when the communication state at the detecting portion 2 changes from “communication existing” to “no communication”, and that the information communication is existing at the detecting portion 2 when the communication state changes from “no communication” to “communication existing”. In other words, the determination portion 16 holds the current determination until the communication state changes, and then alters from the current determination to a different determination once the communication state changes.

Determination by the determination portion 16 is performed instantaneously. Therefore, for some reasons such as instantaneous power loss, the determination may be “no communication” even though the information communication is still existing. Therefore, in order to eliminate such a problem, the determination portion 16 may be configured to determine that the information communication is existing at a given detecting portion 2 when the communication state at the detecting portion 2 is determined to be “communication existing” for several times in succession, and that the information communication is not existing at the detecting portion 2 when the communication state is determined to be “no communication” for several times in succession.

Next, the control flow of the communication monitoring system 1 will be described. The control flow when there are n detecting portions 2 will be described here.

As showing in FIG. 4, firstly, a default value of 1 is assigned to a variable i indicating the port number of the input port 14a (the number of the detecting portion 2) and also a default value of 0 is assigned to a variable t indicating time in Step S1. After switching the switching circuit 14 so that the i^{th} input port 14a is connected to the output port 14b in Step S2, a standby period is provided to wait until the switching operation is stabilized in Step S3.

Then, in Step S4, the determination portion 16 determines whether or not information communication at the i^{th} detecting portion 2 is existing, i.e., whether or not the output voltage of the switching circuit 14 is not less than the threshold voltage. If YES in Step S4, 1 is assigned to a variable I(i, t) indicating the communication state at the i^{th} detecting portion 2 at time t in Step S5 and the process proceeds to Step S7. If No in Step S4, 0 is assigned to the variable I(i, t) in Step S6 and the process proceeds to Step S7.

In Step S7, whether or not the variable t is 0 is determined If YES in Step S7, the process proceeds to Step S10. If No in Step S7, whether or not I(i, t)=I(i, t−1), i.e., whether or not the communication state of this time is different from the communication state of the last time is determined in Step S8. If YES in Step S8, display for the communication state at the i^{th} detecting portion 2 is maintained without change, and the process proceeds to Step S13.

If No in Step S8, whether or not I(i, t)=1 is determined in Step S10. If YES in Step S10, the communication state at the i^{th} detecting portion 2 is changed from “no communication” to “communication existing” in Step S11, and the process proceeds to Step S13. If No in Step S10, the communication state at the i^{th} detecting portion 2 is changed from “communication existing” to “no communication” and the process then proceeds to Step S13.

In Step S13, whether or not the variable i is larger than n is determined. If No in Step S13, the variable i is incremented in Step S14 and the process then returns to Step S2.

If YES in Step S13, 1 is assigned to the variable i and, at the same time, the variable t is incremented in Step S15, and the process then returns to Step S2. To prevent memory pressure due to an increase in the variable I(i, t), the variable t may be reset when the variable t exceeds the preset value even though it is omitted in FIG. 4.

As describe above, the communication monitoring system 1 in the present embodiment is provide with plural detecting portions 2 each of which is provided in the connector 22 provided at an end of the communication cable 4 or in the relay connector 5 to be connected to the connector 22 to branch, extract and output a portion of a signal transmitted through the communication cable 4, and the monitoring unit 3 for monitoring the communication states of the communication cables 4 each having the detecting portion 2 based on the outputs from the plural detecting portions 2.

This configuration allows the communication states of plural communication cables 4 to be collectively monitored and to be prevented from being pulled out by mistake.

In addition, in the present embodiment, it is possible to use a universal communication cable as the communication cable 4 and the cost is therefore low since it is not necessary to provide a monitoring signal line, etc., in the communication cable 4, unlike the conventional technique.

The present invention is not intended to be limited to the embodiment, and it is obvious that the various kinds of changes can be made without departing from the gist of the invention.

For example, the monitoring unit 3 may be provided with an output section for outputting information about the communication state at each detecting portion 2 through a wire or wirelessly, and further provided with a mobile terminal device for receiving and displaying the information from the output section, even though it is not mentioned in the description of the embodiment. This allows connection of the communication cables 4 to be changed while checking the communication state on the mobile terminal device, and workability is thus improved.

In addition, the monitoring unit 3 may be further provided with an alarm portion which generates an alarm, e.g., by sound or light or by sending a management message to a management unit when information communication at a specific detecting portion 2 is interrupted, even though it is not mentioned in the description of the embodiment. In this case, the alarm portion is configured to set at least one of the plural detecting portions 2 as a key monitoring object and to generate an alarm when the communication state at the detecting portion 2 as a key monitoring object is determined to be “no communication”.

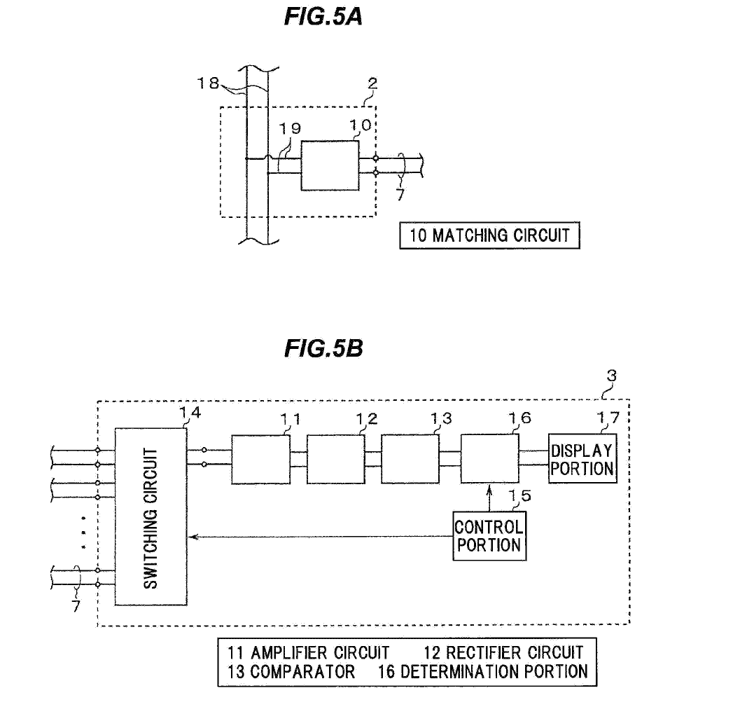

Furthermore, the amplifier circuit 11, the rectifier circuit 12 and the comparator 13 are provided in the detecting portion 2 in the embodiment, but may be provided in the monitoring unit 3 as shown in FIGS. 5A and 5B. In this case, the amplifier circuit 11, the rectifier circuit 12 and the comparator 13 are sequentially provided between the switching circuit 14 and the determination portion 16.

This configuration allows the detecting portion 2 (i.e., the relay connector 5) to be downsized and also the amplifier circuit 11, the rectifier circuit 12 and the comparator 13 to be shared among the detecting portions 2, and it is thus possible to reduce the cost and power consumption of the entire system. Furthermore, by providing the amplifier circuit 11 on the monitoring unit 3, it is possible to suppress deterioration in signal quality caused because the output signal of the amplifier circuit 11 enters the communication cable 4.

In addition, although the detecting portion 2 is connected to the monitoring unit 3 through the monitoring cable 7 in the embodiment, it can be configured that a transmitter for transmitting a signal extracted from the communication cable 4 is provided in the detecting portions 2 and a receiver for receiving the signal transmitted from the transmitter is provided in the monitoring unit 3 so that the signal is transmitted and received wirelessly between the detecting portion 2 and the monitoring unit 3.

In addition, the monitoring unit 3 may be further provided with a usage calculation unit by which the times determined to be “communication existing” at each detecting portion 2 is accumulated and displayed on the display portion 17.

What is claimed is:

1. A communication monitoring system, comprising:
a plurality of detecting portions each provided at a connector at an end of a communication cable or at a relay connector to be connected to the connector to branch, extract and output a portion of a signal transmitted through the communication cable; and
a monitoring unit configured to monitor an existence of information communication through each of the communication cables provided with the detecting portions based on an output from the plurality of detecting portions.

2. The communication monitoring system according to claim 1, wherein the monitoring unit comprises:
a switching circuit comprising a plurality of input ports to receive an output of the plurality of detecting portions and one output port and sequentially changing the input ports to be connected to the output port; and
a determination portion sequentially determining the existence of information communication at the plurality of detecting portions based on an output from the output port of the switching circuit.

3. The communication monitoring system according to claim 2, wherein the determination portion determines that there is information communication at arbitrary one of the detecting portions if the information communication at the arbitrary one changes from “existing” to “not existing”, and that there is no information communication at the arbitrary one if the information communication at the arbitrary one changes from “not existing” to “existing”.

4. The communication monitoring system according to claim 2, wherein the determination portion determines that there is information communication at arbitrary one of the detecting portions if the information communication at the arbitrary one is detected to be “existing” for multiple times in succession, and that there is no information communication at the arbitrary one if the information communication at the arbitrary one is detected to be “not existing” for multiple times in succession.

5. The communication monitoring system according to claim 1, wherein the monitoring unit comprises an output section for outputting information about the existence of the information communication at each of the detecting portions through a wire or wirelessly, and a mobile terminal device for receiving and displaying the information from the output section.

6. The communication monitoring system according to claim 1, wherein the detecting portions comprise a matching circuit configured to adjust a level of the signal extracted from the communication cable.

7. The communication monitoring system according to claim 1, wherein one of the detecting portions and the monitoring unit comprises an amplifier circuit amplifying the signal extracted from the communication cable and outputting the amplified signal, a rectifier circuit rectifying an output from the amplifier circuit into a DC signal and outputting the DC signal, and a comparator outputting a signal with a predetermined voltage if output voltage of the rectifier circuit is not less than a preset threshold voltage.

8. The communication monitoring system according to claim 7, wherein the monitoring unit comprises the amplifier circuit, the rectifier circuit and the comparator.

9. The communication monitoring system according to claim 1, wherein the monitoring unit comprises an alarm portion that sets at least one of the plurality of detecting portions as a key monitoring object and outputs an alarm if the information communication at the detecting portions as the key monitoring object is determined to be “not existing”.
